(19) United States
(12) Patent Application Publication
(10) Pub. No.: US 2026/0194198 A1
(43) Pub. Date: Jul. 9, 2026

(54) VEHICLE HEADLIGHT

(71) Applicant: Autosystems, a division of Magna Exteriors Inc., Aurora (CA)

(72) Inventors: J. R. Scott MITCHELL, Aurora (CA); Traian MIU, Aurora (CA); Gabriele Wayne SABATINI, Aurora (CA)

(21) Appl. No.: 19/416,570

(22) Filed: Dec. 11, 2025

Related U.S. Application Data
(60) Provisional application No. 63/743,316, filed on Jan. 9, 2025.

(51) Int. Cl. F21S 41/275; F21S 41/20; F21S 41/255

(52) U.S. Cl. CPC F21S 41/275; F21S 41/255; F21S 41/2805

(57) ABSTRACT

A headlight assembly for a motor vehicle includes a light source and a plurality of optical elements disposed along an optical path with the light source. Each optical element of the plurality of optical elements includes a plurality of transmission-enhancing features disposed on a surface thereof. The plurality of transmission-enhancing features are configured to increase light transmission through the associated optical element and to decrease reflection therefrom.

### CROSS REFERENCE TO RELATED APPLICATIONS

This U.S. utility patent application claims the benefit of U.S. Provisional Patent Application No. 63/743,316, filed Jan. 9, 2025, the contents of which is incorporated herein by reference in its entirety.

### FIELD

The present disclosure relates generally to vehicle headlight assemblies.

### BACKGROUND

This section provides background information related to the present disclosure which is not necessarily prior art

Modern vehicle headlights, or headlamps are composed of numerous optical to transmit light generated from a light source to illuminate a road. One drawback of modern headlights is the increase in housing sizing required to accommodate an increase light source size when desired to augment the amount of light projected onto the roadway. Additionally, as the light output of the headlight increases, additional components for heat mitigation are required, further adding to the size and cost of the headlight assembly.

### SUMMARY

This section provides a general summary of the disclosure and is not intended to be a comprehensive listing of all features, advantages, aspects and objectives associated with the inventive concepts described and illustrated in the detailed description provided herein.

The present disclosure provides a headlight assembly for a motor vehicle. The headlight assembly includes a light source, and a plurality of optical elements disposed along an optical path with the light source. Each optical element of the plurality of optical elements includes a plurality of transmission-enhancing features disposed on a surface thereof and configured to increase light transmission therethrough and to decrease reflection therefrom.

These and other aspects of the present disclosure are disclosed in the following detailed description of the embodiments, the appended claims, and the accompanying figures.

### BRIEF DESCRIPTION OF THE DRAWINGS

The drawings described herein are for illustrative purposes only of selected non-limiting embodiments and are not intended to limit the scope of the present disclosure. In this regard the drawings include.

FIG. 1 illustrates a motor vehicle with a headlight assembly in accordance with an aspect of the disclosure;

FIG. 2 illustrates an exploded view of a vehicle headlight assembly, in accordance with an illustrative embodiment;

FIGS. 3-4 illustrate a structure and characteristics of an optical element of the headlight assembly having nanostructures disposed on the surface of the optical element.

### DETAILED DESCRIPTION

Referring to the drawings, the present invention will be described in detail in view of following embodiments.

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

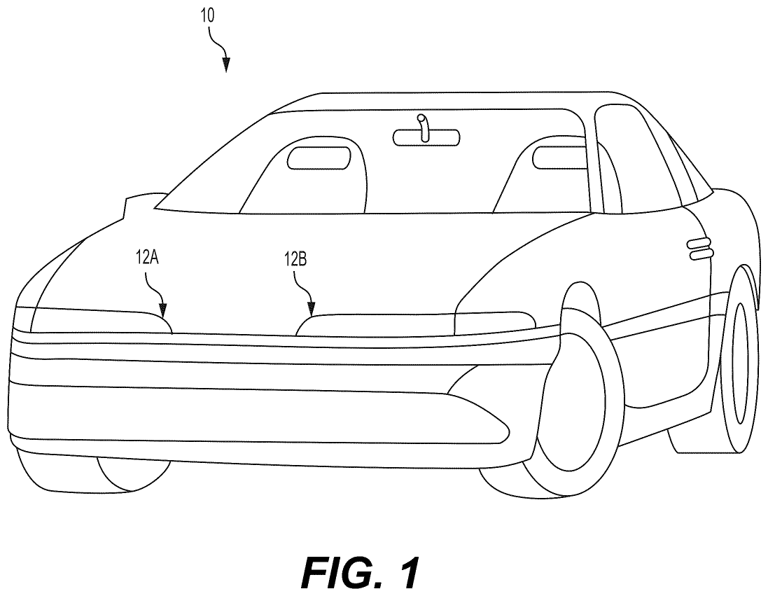

Reference is made to FIG. 1, there is shown a vehicle 10, such as a car, having two headlight assemblies 12A, 12B. The two headlight assemblies include a right headlight assembly 12A and a left headlight assembly 12B

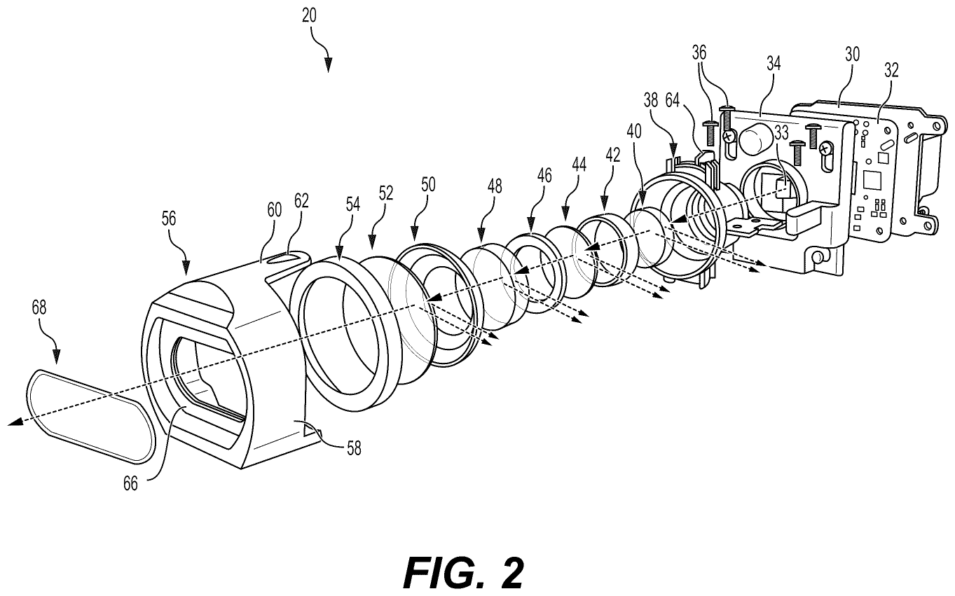

Now referring to FIG. 2, there is shown an exploded view of a lamp assembly 20 for one of the headlight assemblies 12A, 12B. The lamp assembly 20 includes a heat sink 30 and a printed circuit board (PCB) 32 that overlies the heat sink 30. One or more light sources 33, such as LED devices are disposed on the PCB 32 and configured to generate light. The one or more light sources 33 may include an LED array having power electronics associated therewith. A housing 34 surrounds the PCB 32. A lens holder 38 is attached to the housing 34 using a plurality of screws 36.

The lamp assembly 20 also includes a plurality of optical elements that are optically coupled to each other. More specifically, the optical elements in the lamp assembly 20 include a plurality of lenses 40, 44, 48, 52 disposed along an optical path to focus and direct light generated by the one or more light sources 33. However, other types of optical elements, such as filters, mirrors, and/or prisms may be used. The plurality of lenses 40, 44, 48, 52 includes a first lens 40, a second lens 44, a third lens 48, and a fourth lens 52. The first lens 40 is disposed adjacent to the one or more light sources 33 for receiving light therefrom, and the second lens 44 is next adjacent in an optical path for receiving light from the first lens 40. The lamp assembly 20 also includes a first spacer ring 42 with an annular shape disposed between the first lens 40 and the second lens 44 for maintaining a predetermined distance therebetween.

The third lens 48 is next adjacent in an optical path for receiving light from the second lens 44. The lamp assembly 20 also includes a second spacer ring 46 with an annular shape disposed between the second lens 44 and the third lens 48 for maintaining a predetermined distance therebetween. The fourth lens 52 is next adjacent in an optical path for receiving light from the third lens 48. The lamp assembly 20 also includes a third spacer ring 50 with an annular shape disposed between the third lens 48 and the fourth lens 52 for maintaining a predetermined distance therebetween.

The lamp assembly 20 also includes a cover 56 with a body 58 having a tubular shape that surrounds the plurality of lenses 40, 44, 48, 52 and the lens holder 38. The lamp assembly 20 also includes a fourth spacer ring 54 with an annular shape disposed between the fourth lens 52 and the cover 56 for maintaining a predetermined distance therebetween. The fourth spacer ring 54 may be made of a resilient material for preventing vibration between the fourth lens 52 and the cover 56. The cover 56 includes a tab 60 that extends rearward, toward the housing 34. The tab 60 defines an aperture 62. The lens holder 38 includes a protrusion 64 that extends upwardly and which is configured to fit into the aperture 62 in the tab 60 of the cover 56 for retaining the cover 56 to the lens holder 38 and the housing 34.

The cover 56 also defines a recess 66 opposite of the plurality of lenses 40, 44, 48, 52. A lens cover 68 is disposed in the recess 66, overlying the fourth lens 52. The lens cover 68 may be configured to pass light therethrough without distortion, such as by including two parallel surfaces.

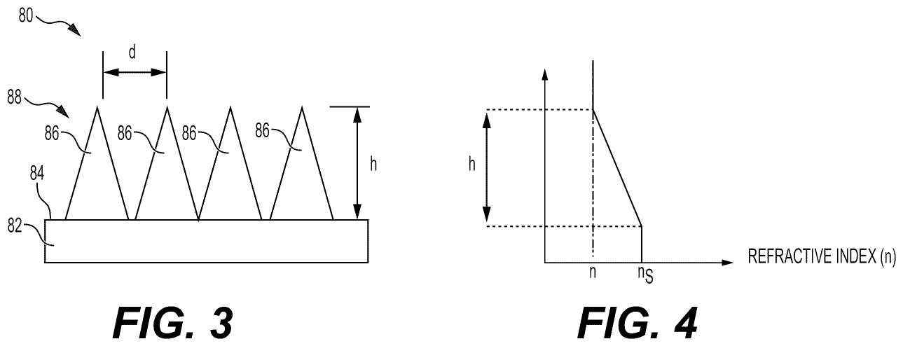

Each of the plurality of lenses 40, 44, 48, 52, includes a surface 84 having nanostructures, as shown in FIGS. 3-4. Table 1, below, lists transmission efficiencies at various optical interfaces of the vehicle headlight assembly.

TABLE 1
Transmission Efficiencies at Various Optical Interfaces

| | | | Trans- | |
|---|---|---|---|---|
| | | | mission | Reflection |
| | Air | | 100.0% | |
| Lens 1 (40) | Air to Glass | | 99.5% | 0.5% |
| | Glass to Air | | 99.0% | 0.5% |
| Lens 2 (44) | Air to PMMA | | 98.5% | 0.5% |
| | PMMA to Air | | 98.0% | 0.5% |
| Lens 3 (48) | Air to PMMA | | 97.5% | 0.5% |
| | PMMA to Air | | 97.0% | 0.5% |
| Lens 4 (52) | Air to PMMA | | 96.6% | 0.5% |
| | PMMA to Air | | 96.1% | 0.5% |
| Lens Cover | Air to PC | | 95.1% | 1.0% |
| (68) | PC to Air | | 94.2% | 1.0% |
| | | TOTAL | 94.2% | |
| | | TRANSMISSION | | |

As indicated, the first lens 40 may be made of glass. The second lens 44, the third lens 48, and the fourth lens 52 may each be made of polymethyl methacrylate (PMMA), and the lens cover 68 may be made of Polycarbonate (PC). However, any or all of the lenses 40, 44, 48, 52, and/or the lens cover 68 may be made of a different material.

FIG. 3 shows a schematic cross-section of an optical element 80. The optical element 80 may describe any or all of the lenses 40, 44, 48, 52 in the lamp assembly 20. The optical element 80 includes a substrate 82 that defines a surface 84. The substrate 82 may have a first refractive index n_{S}. A plurality of nanostructures 86 protrude from the surface 84 of the substrate 82. The plurality of nanostructures 86 may be formed together on the surface 84 of the substrate 82 as an additional optical layer, such as by application of a film 88 on the surface 84 of the substrate 82. Alternatively, the plurality of nanostructures 86 may be integrally formed with the substrate 82 of the optical element 80.

FIG. 3 also illustrates a distance d between corresponding parts of two adjacent ones of the nanostructures 86, in a direction parallel to the surface 84. The nanostructures 86 may define a regular pattern with the same distance d between corresponding parts of each adjacent ones of the nanostructures 86. Alternatively, the distances d between corresponding parts of two adjacent ones of the nanostructures 86, in a direction parallel to the surface 84 may be different. For example, as shown by the middle two nanostructures 86 on FIG. 3, two adjacent ones of the of the nanostructures 86 may contact adjacent ones of the nanostructures 86 where they each meet the surface 84, whereas each middle ones of the nanostructures 86 is spaced apart from other ones of the nanostructures 86, shown far left and right on FIG. 3.

FIG. 3 also illustrates a height h of the nanostructures 86 in a direction perpendicular to the surface 84. Each of the nanostructures 86 may have a same height h. FIG. 4 shows a graph illustrating a relationship between the height h of the nanostructures 86 and a difference in refractive index (n). As shown, the nanostructures 86 define a refractive index (n) that progressively increases with the height h. More specifically, the refractive index (n) increases linearly with the height h from the first refractive index n_{S} of the substrate 82. The nanostructures 86 are shown with a constant slope, and therefore, the refractive index (n) varies proportional to distance along a direction parallel to the surface 84. However, the nanostructures 86 may have a different physical arrangement or structure.

Each of the lenses 40, 44, 48, 52 may have nanostructures 86 applied to each of its surfaces, such as on both opposite sides of each lens. The lens cover 68 may also have nanostructures 86 applied to each of its surfaces. As a result, the nanostructures 86 may increase the optical efficiency of the headlight assembly 12A, 12B by increasing the light transmission originating from the light source and by reducing the amount of reflection. Consequentially, the light output of the light source can reduced, and the size of the light source can also be reduced, providing a size and cost reduction of the light assembly. Additionally, an LED array of the light source can be selected to emit less light, resulting in cost savings. Additionally, power consumption of the light sources 33 can be reduced, providing energy efficiencies and a corresponding elimination or reduction in the size of heat dissipation elements. For example, the lamp assembly 20 may not require a heat sink, and thus the headlight assembly may also not include a heat sink, saving a significant portion of cost, packaging size, and also resulting in weight savings.

The present disclosure provides a headlight assembly for a motor vehicle. The headlight assembly includes a light source, and a plurality of optical elements disposed along an optical path with the light source. Each optical element of the plurality of optical elements includes a plurality of transmission-enhancing features disposed on a surface thereof and configured to increase light transmission therethrough and to decrease reflection therefrom. For example, the plurality of transmission-enhancing features may cause the associated optical element to have increased light transmission properties and reduced reflectance when compared with a similar or identical optical element without the transmission-enhancing features. In some cases, including the plurality of transmission-enhancing features may cause the associated optical element to have substantially increased light transmission properties when compared with a similar or identical optical element without the transmission-enhancing features.

In some embodiments, each optical element of the plurality of optical elements defines an input surface for receiving light from the light source, and an output surface for emitting light therefrom, and wherein the plurality of transmission-enhancing features are disposed on each of the input surface and the output surface.

In some embodiments, each optical element of the plurality of optical elements defines a surface, and wherein the plurality of transmission-enhancing features are disposed on the surface.

In some embodiments, the plurality of transmission-enhancing features include nanostructures formed on the surface of the optical element.

In some embodiments, the nanostructures define a regular pattern with a same distance between corresponding parts of adjacent ones of the nanostructures.

In some embodiments, the nanostructures define an irregular pattern with different distances between corresponding parts of adjacent ones of the nanostructures.

In some embodiments, at least some of the nanostructures contact adjacent ones of the nanostructures where they each meet the surface.

In some embodiments, the nanostructures each have a same height in a direction perpendicular to the surface.

In some embodiments, the nanostructures each have a refractive index that varies with a height perpendicular to the surface.

In some embodiments, the nanostructures each have a refractive index that varies along a direction parallel to the surface.

In some embodiments, the refractive index of each of the nanostructures varies proportional to distance along the direction parallel to the surface.

In some embodiments, the headlight assembly further includes a film of material disposed on the surface of each optical element, and the film includes the plurality of transmission-enhancing features.

In some embodiments, the plurality of transmission-enhancing features are integrally formed with each optical element.

In some embodiments, the plurality of optical elements includes a plurality of lenses each configured to focus and direct light from the light source.

In some embodiments, the plurality of optical elements further includes a lens cover overlying the plurality of lenses, wherein the lens cover is configured to pass light therethrough without distortion, and wherein the lens cover includes another plurality of transmission-enhancing features configured to increase light transmission through the lens cover and to decrease reflection therefrom.

In some embodiments, the headlight assembly does not include a heat sink.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A headlight assembly for a motor vehicle, comprising:
a light source; and
a plurality of optical elements disposed along an optical path with the light source,
wherein each optical element of the plurality of optical elements includes a plurality of transmission-enhancing features disposed on a surface thereof and configured to increase light transmission therethrough and to decrease reflection therefrom.

2. The headlight assembly of claim 1, wherein each optical element of the plurality of optical elements defines an input surface for receiving light from the light source, and an output surface for emitting light therefrom, and wherein the plurality of transmission-enhancing features are disposed on each of the input surface and the output surface.

3. The headlight assembly of claim 1, wherein each optical element of the plurality of optical elements defines a surface, and wherein the plurality of transmission-enhancing features are disposed on the surface.

4. The headlight assembly of claim 3, wherein the plurality of transmission-enhancing features include nanostructures formed on the surface of the optical element.

5. The headlight assembly of claim 4, wherein the nanostructures define a regular pattern with a same distance between corresponding parts of adjacent ones of the nanostructures.

6. The headlight assembly of claim 4, wherein the nanostructures define an irregular pattern with different distances between corresponding parts of adjacent ones of the nanostructures.

7. The headlight assembly of claim 4, wherein at least some of the nanostructures contact adjacent ones of the nanostructures where they each meet the surface.

8. The headlight assembly of claim 4, wherein the nanostructures each have a same height in a direction perpendicular to the surface.

9. The headlight assembly of claim 4, wherein the nanostructures each have a refractive index that varies with a height perpendicular to the surface.

10. The headlight assembly of claim 4, wherein the nanostructures each have a refractive index that varies along a direction parallel to the surface.

11. The headlight assembly of claim 10, wherein the refractive index of each of the nanostructures varies proportional to distance along the direction parallel to the surface.

12. The headlight assembly of claim 1, further including a film of material disposed on the surface of each optical element, and wherein the film includes the plurality of transmission-enhancing features.

13. The headlight assembly of claim 1, wherein the plurality of transmission-enhancing features are integrally formed with each optical element.

14. The headlight assembly of claim 1, wherein the plurality of optical elements includes a plurality of lenses each configured to focus and direct light from the light source.

15. The headlight assembly of claim 14, wherein the plurality of optical elements further includes a lens cover overlying the plurality of lenses, wherein the lens cover is configured to pass light therethrough without distortion, and wherein the lens cover includes another plurality of transmission-enhancing features configured to increase light transmission through the lens cover and to decrease reflection therefrom.

16. The headlight assembly of claim 1, wherein the headlight assembly does not include a heat sink.
